(19) United States
(12) Patent Application Publication
(10) Pub. No.: US 2026/0161265 A1
(43) Pub. Date: Jun. 11, 2026

(54) AGENT CONTROL USING VISION AND LANGUAGE MODELS

(71) Applicant: GOOGLE LLC, Mountain View, CA (US)

(72) Inventors: Marc Stogaitis, San Jose, CA (US); Mimi Sun, San Jose, CA (US)

(21) Appl. No.: 19/058,536

(22) Filed: Feb. 20, 2025

Related U.S. Application Data
(60) Provisional application No. 63/728,342, filed on Dec. 5, 2024.

(51) Int. Cl. G06F 3/0482; G06F 21/53; G10L 15/26

(52) U.S. Cl. CPC G06F 3/0482; G06F 21/53; G10L 15/26

(57) ABSTRACT

Some implementations disclosed herein are directed to using a visual input scheme for a VLM that relies on a set-of-mark strategy and indexing so that the visual-to-UI-anchor association is clear for the vision and language model (VLM). The VLM can thus be used to control a graphical user interface (GUI) based on natural language queries input by a user. The natural language query can indicate a target task to be performed via the GUI and can be input into a VLM alongside an annotated image of the GUI that contains visual indications of the interactable elements, each with a respective index value. The VLM can process this input to generate data indicating one or more actions to be taken via the GUI and, for an action, a corresponding index of the interactable element in the GUI at which the action can be taken.

### BACKGROUND

Various generative models have been proposed that can be used to process natural language (NL) content, vision and/or other input(s), to generate output that reflects generative content that is responsive to the input(s). For example, vision and language models (VLM(s)) have been developed that can be used to process NL content and visual content (and/or other input(s)), to generate VLM output that that reflects NL content and/or other content that is responsive to the input(s). For instance, a VLM can be used to process NL content of “What type of animal is shown in this picture” and visual content in the form of an image, to generate VLM output that reflects several responsive NL sentences such as: “The image shows a cat”. However, current utilizations of generative models suffer from one or more drawbacks.

As one example, VLMs can be utilized as part of a text-based dialogue application, generating responses to textual inputs/queries provided by a user of the application. A VLM can typically understand what a user is asking and turn it into a sequence of actions. However, current VLMs cannot cause those actions to be implemented, much less across a sequence of images. Since functionality is often hidden behind, e.g., applications that require screen taps, and/or websites that require clicks, this functionality is generally inaccessible to current VLMs.

### SUMMARY

Implementations disclosed herein are directed to at least allowing a VLM (or other multi-modal generative model) to access and control user interfaces of applications, programs, operating systems (OS(s)), etc. The VLM can thus access and utilize data that is otherwise locked away in application and/or website silos. By allowing a VLM to control an OS in the same way a user does, the VLM can retrieve siloed information to assist users with data that is relevant to them. A natural language query can be received via a user device. The natural language query can relate to information that is accessible via a GUI, e.g., a GUI of an application or web browser. For example, the natural language query may include a request for information and/or a request for one or more target tasks to be performed. The natural language query can be input into a VLM alongside an annotated image of the relevant GUI and structural information relating to the layout of the GUI, e.g., the relative positions of the GUI element. In some implementations, the image of the GUI can contain visual indications of the interactable elements of the GUI, each with a respective index value. Alternatively, or additionally, the structural information relating to the GUI may include indices for the interactable elements of the GUI. The VLM can process this input to generate data indicating one or more actions to be taken via the GUI. The action can then be performed automatically at the indicated interactable element of the GUI, for example, via an OS or application running virtually. This process may be repeated until information for responding to the input query has been gathered and/or tasks relevant to the query have been performed. A response to the input query can then be generated based on the gathered data.

For example, a user input can include the request “Make me a graph of my monthly streaming application usage” through an assistant application on a user device. The VLM may iteratively generate a sequence of actions that cause the relevant streaming applications to be opened (e.g., in a virtual machine), and the user history for each application to be located and retrieved. The VLM can then cause a graph of the streaming application usage to be generated, e.g., using a first party or third party graph application, and output the graph to the user via the assistant application. In some implementations, and during this process, the VLM may cause intermediate output describing current actions being taken to be rendered via the assistant application, e.g., “I'm loading your application 1 history”, “Now loading application 2 history”, etc.

In these, and other, manners, the VLM can provide personalized output to natural language queries that utilizes data from multiple first party sources and/or third-party sources, overcoming the issues associated with user data being siloed behind disparate user applications. In various implementations, the VLM model can be utilized to perform actions through third party applications without a user having to run the application locally on a user device, thereby saving memory and power at the user device.

In some implementations, an LLM or VLM can include at least hundreds of millions of parameters. In some of those implementations, the LLM/VLM includes at least billions of parameters, such as one hundred billion or more parameters. In some additional or alternative implementations, an LLM/VLM is a sequence-to-sequence model, is Transformer-based, and/or can include an encoder and/or a decoder. One non-limiting example of an LLM is GOOGLE'S Pathways Language Model (PaLM). Another non-limiting example of an LLM is GOOGLE'S Language Model for Dialogue Applications (LaMDA). One non-limiting example of a VLM is GOOGLE'S GEMINI Model. However, as noted, it should be noted that the LLMs/VLMs described herein are one example of generative machine learning models that are not intended to be limiting.

For example, the LLM/VLM described herein can be a generative model. A generative model can be any sequence-to-sequence based machine learning model capable of generating generative vision data, generative audio data, generative textual data, and/or other forms of generative data. Some non-limiting examples of sequence-to-sequence based machine learning models that are capable of generating one or more forms of the generative data noted above include transformer-based machine learning models (e.g., encoder-decoder transformer models, encoder-only transformer models, decoder-only transformer models, etc. that optionally employ an attention mechanism or some other form of memory), stable diffusion-based machine learning models, recurrent neural network-based machine learning models, generative adversarial network-based machine learning models, etc. Various sequence-to-sequence based machine learning models have demonstrated multimodal capabilities in that they are capable of processing inputs in one or more modalities (e.g., text-based inputs, vision-based inputs, audio-based inputs, etc.) and generating outputs in one or more modalities (e.g., text-based output, vision-based outputs, audio-based generative outputs, etc.). Some particular non-limiting examples of these sequence-to-sequence based machine learning models that have demonstrated multimodal capabilities include the Gemini family of models, the ChatGPT family of models, the Claude family of models, the Llama family of models, and/or other families of sequence-to-sequence generative models.

As used herein, a “first party” is an entity that develops, controls, and/or manages the LLM/VLM or generative model, whereas a “third party” is an entity that is distinct from the entity that develops, controls, and/or manages the LLM/VLM or generative model. Accordingly, a first party application can be an application that is associated with the entity that develops, controls, and/or manages the LLM/VLM or generative model. Further, a third party application can be an application that is associated with any entity that is distinct from the entity that develops, controls, and/or manages the LLM/VLM or generative model.

The preceding is presented as an overview of only some implementations disclosed herein. These and other implementations are disclosed in additional detail herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts an overview of an example method of controlling a user interface using a VLM, in accordance with various implementations.

FIG. 3 illustrates an overview of an example system 300 for responding to an input prompt to an LLM using one or more external applications, in accordance with various implementations.

FIG. 4 illustrates an example of an annotated image of a graphical user interface, in accordance with various implementations.

FIG. 5 illustrates a flow diagram of an example method for controlling a user interface using a VLM, in accordance with various implementations.

FIG. 6 depicts an example architecture of a computing device, in accordance with various implementations.

### DETAILED DESCRIPTION

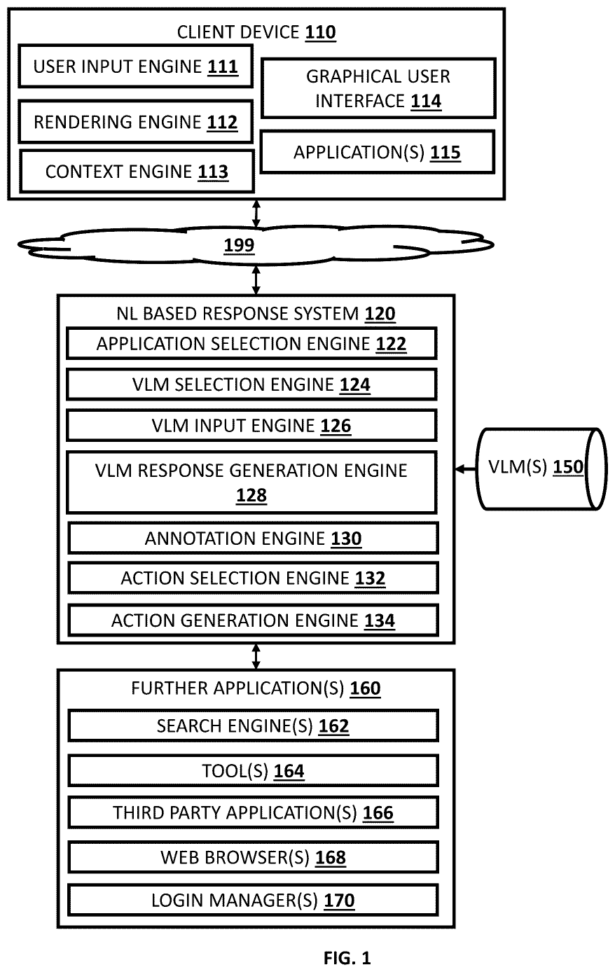

Turning now to FIG. 1, a block diagram of an example environment that demonstrates various aspects of the present disclosure, and in which implementations disclosed herein can be implemented is depicted. The example environment includes a client device 110, a natural language (NL) response system 120, and one or more further applications 160 (e.g., applications external to a VLM or a dialogue application executed on the client device 110). Although illustrated separately, in some implementations, all or aspects of the NL based response system 120 and all or aspects of the one or more further applications 160 can be implemented as part of a cohesive system.

In some implementations, all or aspects of the NL based response system 120 can be implemented locally at the client device 110. In additional or alternative implementations, all or aspects of the NL based response system 120 can be implemented remotely from the client device 110 as depicted in FIG. 1 (e.g., at remote server(s)). In those implementations, the client device 110 and the NL based response system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker having a display, a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application(s) 115, via which queries can be submitted and/or response(s) to the query can be rendered (e.g., audibly and/or visually). The application(s) 115 can be an application that is separate from an operating system of the client device 110 (e.g., one installed “on top” of the operating system) - or can alternatively be implemented directly by the operating system of the client device 110. For example, the application(s) 115 can be a web browser installed on top of the operating system (OS), or can be an application that is integrated as part of the operating system functionality. The application(s) 115 can interact with the UI control system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of a query described herein can be a query that is formulated based on user input provided by a user of the client device 110 and detected via user input engine 111. For example, the query can be a typed query that is typed via a physical or virtual keyboard, a suggested query that is selected via a touch screen or a mouse, a spoken voice query that is detected via microphone(s) of the client device, or an image query that is based on an image captured by a vision component of the client device.

In various implementations, the client device 110 can include a rendering engine 112 that is configured to provide content (e.g., an NL based summary) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In some of those implementations, the context engine 113 can determine a context utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a current state of a query session (e.g., considering one or more recent queries of the query session), profile data, and/or a current location of the client device 110. As an example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render result(s) (e.g., an NL based summary) for an implied query.

In various implementations, the client device 110 can include one or more graphical user interfaces (GUI(s)) 114. A GUI 114 is configured to provide a visual user interface to the user via a display of the client device 110 through which the user can interact with application(s) 115 associated with the GUI 114. One or more applications 115 on the user device 110 may each be associated with a respective GUI 114. For example, a GUI 114 may be associated with an operating system of the user device 110. A GUI 114 may be associated with a web browser of the user device 110. Many other examples are possible. A GUI 114 can include one or more interactable elements (e.g., icons, links, buttons, text input boxes, scroll bars, etc.) through which a user can interact (e.g., through touch, typing, a mouse cursor, etc.) with the application(s) 115 associated with the GUI 114.

Further, the client device 110 and/or the NL based response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

NL based response system is illustrated as including an application selection engine 122, a VLM selection engine 124, a VLM input engine 126, a VLM response generation engine 128, an annotation engine 130, an action selection engine 132 and an action generation engine 134. Some of the engines can be omitted/combined in various implementations. In some implementations, the engines of the NL based response system 120 are distributed across one or more computing systems. In general, NL based response system 120 is configured to receive a natural language query via the client device 110, and to process the natural language query to generate a response to the natural language query and/or perform one or more actions via one or more further applications 160.

The application selection engine 122 can, in response to receiving a query, determine one or more further applications 160 to invoke. The application selection engine 122 can select applications that are relevant to the query, e.g., determine that the input query is directed towards subject matter within the domain of one or more further applications 160, and select/invoke one or more of the further applications 160 in response. For example, if the input query involves utilization of a webpage, then the application selection engine 122 can select a web browser application as one or more of the further application 160 to then access the webpage. It should be understood that the one or more further applications 160 can include any application that is accessible at the client device 110 and/or the NL based response system 120.

The VLM selection engine 124 can, in response to receiving a query, determine which, if any, of multiple generative model(s) (VLM(s) 150 and/or other multi-modal generative model(s)) to utilize in generating action(s) responsive to the user query. For example, the VLM selection engine 124 can select none, one, or multiple generative model(s) to utilize in generating action(s) in furtherance of the task indicated by the user query. The VLM selection engine 124 can optionally utilize one or more classifiers and/or rules (not illustrated).

The VLM input engine 126 can, in response to receiving a query, generate VLM input that is to be processed using a VLM in generating action(s) (or GUI action(s)) in response to the query. As described herein, such VLM input can include query content that is based on the query and/or additional content, such as contextual information derived from the context engine 113. The VLM input engine 126 may further retrieve structural information relating to the GUI 114 or relating to the layout of the GUI 114, e.g., data indicating the relative positions of the elements of the GUI 114. In some examples, the structural information can include a document object model (DOM) tree for the GUI 114.

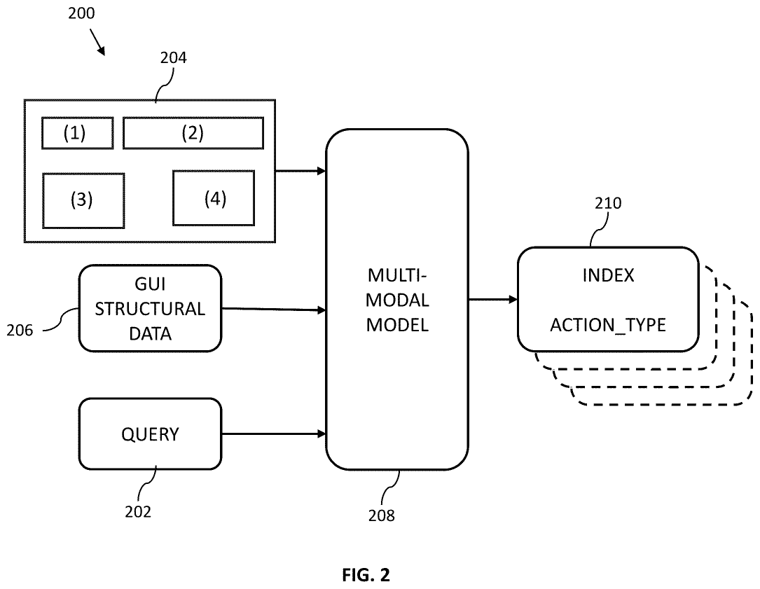

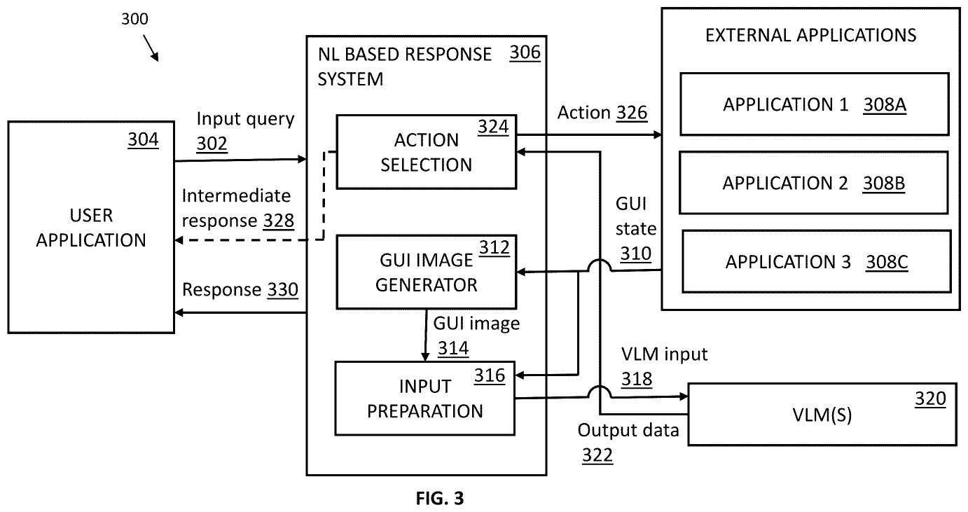

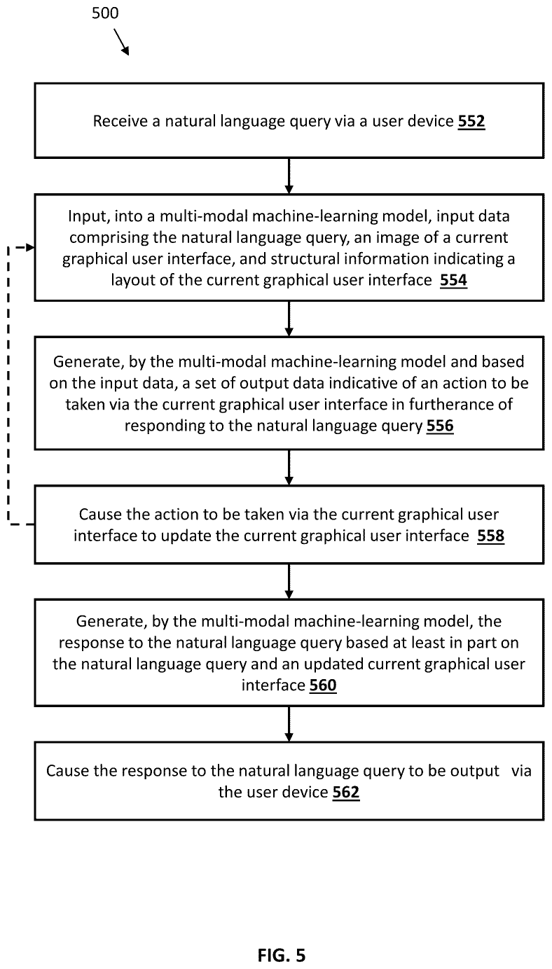

The VLM response generation engine 128 can process VLM input that is generated by the VLM input engine 126, using a VLM, to generate output data indicating one or more actions to be performed via the GUI 114 in furtherance of the task. The output data, for example, can include data indicating an action type (e.g., a click, a text entry, etc.) and an index of an interactable element in the GUI 114 at which to perform the action. In some examples, the output data can include a plurality of candidate actions and respective indices. In various implementations, the VLM response generation engine 128 can perform all or aspects of the multi-modal model(s) 208, 320 of FIG. 2 and FIG. 3, respectively, and/or blocks 554-558 of method 500 of FIG. 5. The VLM response generation engine 128 can utilize one or more VLMs 150.

The annotation engine 130 can, in response to receiving a query, generate an annotated image of a GUI, e.g., the GUI 114 of the user device or a (virtual) GUI of one or more further applications 160. The annotated image of a GUI can include an image of a GUI in which one or more interactable elements of the GUI are indicated and each associated with a respective index. The respective index for each interactable element is indicated in the annotated image. For example, in some implementations, each interactable element is indicated with a respective numbered/lettered bounding box. The annotation engine 130, in some implementations, generates the annotated image of the GUI from structural information relating to the layout of the GUI, e.g., data indicating the relative positions of the elements of the GUI. In some examples, the structural information can include a document object model (DOM) tree for the GUI, a subset of the DOM tree for the GUI that is relevant to the task, or a subset of the DOM tree that corresponds to a displayed portion of the GUI 114.

The action selection engine 132 can select one or more actions from, for example, the set of candidate actions output by the VLM response generation engine 128. The action selection engine 132 can, in some examples, select the candidate action with the highest confidence score for performance by the user device 110. In some examples, the action selection engine 132 can compare the confidence scores of the candidate actions to a threshold score. The selected action is selected from the set of candidate actions with a confidence score that exceeds the threshold score. If no candidate action has a confidence score that exceeds the threshold score, the action selection engine 132 may select a default action, e.g., an action that outputs a request for further information via the client device 110.

The action generation engine 134 can convert the action selected by the action section engine 132 into one or more commands for an application that, when implemented by an application on the client device, 110, or by one or more further applications 160 cause the application to perform the selected action.

The one or more further applications 160 is illustrated as including one or more search engines 162, one or more tools 164, one or more third-party applications 164, one or more web browsers 166 and/or one or more login managers 170. Some of the engines can be omitted in various implementations. Further applications may also be included in the one or more further applications 160, such as one or more first party applications and/or other applications. One or more of the further applications 160 may be associated with a respective GUI. The one or more further applications 160 may be executed on a virtual machine, e.g., in a secure virtual environment, such as in a secure environment in the cloud or locally on the client device 110.

The one or more search engines 162 can receive a search request from the NL based response system 120 and/or client device 110 and perform a search operation on a search space. The one or more search engines 162 can return one or more search results to the NL based response system 120 and/or the client device 110. The one or more search engines 162 can include an internet search engine.

The one or more tools 164 include, for example, applications that can be used to perform creative tasks, such as one or more image tools for creating and/or editing images, one or more document tools for reading, writing and/or editing documents, one or more audio tools for listening to, creating and/or editing audio. Many other examples are possible and are also contemplated herein.

The one or more third party applications 166 can include applications that are hosted and/or controlled by a third party for providing access to services that they provide. Examples of such third party applications include, but are not limited to: booking applications; e-commerce applications; translation applications; utility provider applications; calendar/diary applications; and/or the like.

The one or more web browsers 168 are applications that provide access to internet webpages.

The one or more login managers 170 can securely store login credentials (e.g., login names, passwords, etc.) of a user for respective application and/or webpages. The login manager can automatically input relevant login details to an application when it is accessed and/or to a webpage when it is loaded. However, it should be noted that the NL based response system 120 can ensure that any login credentials are not included in any VLM input, but the action selection engine 132 and/or the action generation engine 134 can cause any needed login credentials to be utilized.

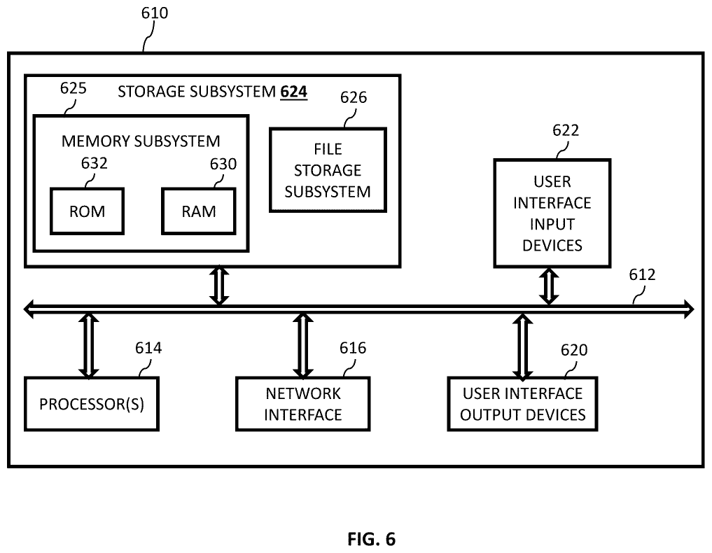

Turning now to FIG. 2, an overview of an example method 200 of controlling a user interface using a VLM is depicted. The method 200 may be performed by one or more computing systems, such as the NL based response system 120 of FIG. 1 and/or computing device 610 described herein with respect to FIG. 6.

A natural language query 202 is received from a user via a user device. The natural language (NL) query 202 is input into a multi-modal model 208 (e.g., a VLM) along with an annotated image 204 of a (current) GUI of application related to the NL query 202 and GUI structural data 206 relating to the layout of the GUI. The multi-modal model 208 processes the NL query 202, the annotated image 204 and the GUI structural data 206 to generate a set of output data 210 that can include an action to be taken through the GUI in furtherance of responding to the query. The output data 210 can be converted into instructions for the relevant application that cause the application to execute the identified action. The method 200 may be iterated to retrieve information relevant to responding to the NL query 202 and/or to perform a target task requested in the NL query 202.

The NL query 202 can be received via a user interface of the user device. The NL query 202 is, in some examples, received in the form of an input text query. The NL query 202 can, for example, originate as text input manually by a user of the user device. Alternatively, or additionally, the NL query 202 can originate from a spoken input to the user device, e.g. a spoken query input after invoking a user application. The spoken input is optionally converted to the NL query 202 by a speech-to-text engine running on the client device (either as part of a user application, or accessible by a user application). The NL query 202 is, in some examples, part of an ongoing human-computer dialogue, e.g. a sequence of input queries (with or without corresponding input images) and their corresponding responses in an application.

In some examples, the NL query 202 can include data in one or more further modalities (e.g., non-text-based NL input data). For example, the NL query 202 can further include one or more images input via the user device. Alternatively, or additionally, the NL query 202 can further include one or more audio samples, e.g., audio data capturing spoken input, music, etc.

The NL query 202 can reference a target task explicitly or implicitly. For example, the NL query 202 may be an explicit request to perform a task, e.g., “Please add three large onions to my shopping order” or “Edit this picture of me to show me in a more fun location”. Alternatively, the natural language query 202 may be an implicit request to perform a task, e.g., “What is my current memory usage” implicitly refers to the task of accessing and retrieving a device memory usage.

The image 204 can include an image of a GUI of an application related to the NL query 202 that the system is interacting with. The application may be selected from a set of applications (e.g., one or more of the further applications 160) based on the NL query 202. For example, the NL query 202 may explicitly or implicitly refer to one or more entities associated with respective applications and/or webpages. Instances of these applications and/or webpages are, in some examples, instantiated in a virtual environment through which the VLM system can interact with them to generate a response to the NL query 202. For example, an instance of each application may be initialized in a virtual machine, such as a secure virtual environment in the cloud or locally at a client device.

The annotated image 204 of the GUI, in some examples, can include at least a portion of the GUI that would not be visible via a display of the user device if displayed. For example, the annotated image 204 of the GUI can include a full image of an operating system GUI, an application GUI, a document, a webpage/browser or the like, e.g., portions that are not visible on the display of a user device when viewed, but that could be reached by scrolling or swiping. As a further example, the annotated image 204 of the GUI may include a GUI that is not currently visible on the display of the user device, e.g., is currently minimized and/or running as a background process.

In some examples, the image of the GUI can include one or more annotations that each indicate a respective interactable element of the GUI. Each annotation includes a respective index, e.g., a (unique) numerical or alphabetical index. Interactable elements of the GUI are GUI elements that a user can interact with, for example by clicking, touching, typing into, selecting, highlighting or the like. Some non-limiting examples of such interactable elements can include: text boxes (such as search bars or the like); GUI icons; hyperlinks; toolbar elements; command line interfaces; sections of copyable text; selectable images, and/or the like. Such interactable elements can typically be identified from the structural information relating to the layout of the GUI, e.g., data that indicates the positions of GUI elements when displayed. An example of such structural data for a webpage is a Document Object Model (DOM). The annotations for the annotated image 204 are, in some examples, generated using the structural data of the GUI, e.g., the structural data may be edited to insert the indications of the interactable elements and their corresponding indices.

In some implementations, the annotations can include one or more bounding boxes for interactable elements of the GUI. The bounding boxes can be indexed with numbers, letters, alphanumeric sequences, or the like.

As an example, the GUI can be a webpage, e.g., a webstore page, that can include one or more selectable links, one or more navigation icons, a search bar for inputting a text search, and a button for initiating a search on the input text. In such an example, the annotated image of the GUI 204 can include a respective bounding box around each of the one or more selectable links, each of the one or more navigation icons, the search bar, and the button for initiating a search on the input text, each with a respective index assigned to them.

Generation of the annotated image 204 is, in some examples, initiated once the user has input the input query 202. In some such examples, the system performing the method 200 determines whether the input query 202 relates to a target task (e.g., using a suitably prompted LLM or a classification model), and initiates the generation of the annotated image 204 in response to a positive determination. This can prevent unnecessary generation of annotated GUI images 204 when the input query 202 does not relate to a target task.

Alternatively, in some examples, generation of the annotated image 204 is initiated as soon as a user starts inputting a query 202. This can reduce latency when the user submits a query that relates to a target task.

Alternatively, in some examples, generation of the annotated image 204 is initiated during entry of the input query by the user in response to the system determining that a partially complete input query is likely to relate to a target task, e.g., has a probability of relating to a target task (as determined by some model) that is above a threshold probability value. Such an approach can balance the latency of the response with the amount of compute required.

The GUI structural data 206 for a GUI (also referred to herein as structural information) can include data indicating a layout of the corresponding GUI. The GUI structural data 206 indicates the elements of the GUI and may indicate their respective locations in the GUI when rendered. The GUI structural data 206 indicates, for one or more of the elements, an element type. For example, the GUI structural data 206 may indicate that a GUI element is an icon, a link, a text box, a button, and/or the like. An example of a set of structure data for a GUI is the Document Object Model (DOM) of a webpage. Another example of a set of structured data for a GUI is Extensible Markup Language (XML) of a webpage or an application of an operating system of a mobile device.

In some examples, the structural data 206 for a GUI can include a proper subset of a full set of structural data 206 for the GUI. For example, the structural data for the interactable elements of the GUI can be extracted from the full set of structural elements for a GUI and used as input to the multi-modal model 208. In other examples, the full set of structural data for the GUI is input into the multi-modal model 208.

In some implementations, the GUI structural data 206 for a GUI may be edited to insert a respective index for each of the interactable elements prior to input into the multi-modal model 208. The interactable elements of the GUI can be identified within the structural data, e.g., based on an element type, and additional annotations can be added to the structural data 206 to provide indices for the interactable elements. In some examples, bounding boxes for the interactable elements can be added to the GUI structural data 206. Each time the GUI changes, the interactable elements can be reindexed, allowing for changes in the GUI to be accounted for. For example, for a webpage, the DOM can be edited inline to insert reference numerals for each interactable element. Each time the webpage changes, the interactable elements can be reindexed, allowing changes to the webpage to be accounted for.

The multi-modal model 208 is a machine learning model that takes input data in at least two modalities, i.e., in at least a natural language modality and a vision modality. An example of such a multi-modal model 208 is a VLM. The multi-modal model 208 has, in some examples, a transformer-based architecture, e.g., can include one or more transformer layers, or other architectures described herein.

The output of the multi-modal model is one or more sets of output data 210. A set of output data 210, in some examples, can include an indication of an action type, e.g., a token representing an action that can be taken via the GUI. In examples where interactable elements of the GUI are indexed, the set of output data can further include an index of the interactable element at which the action should be taken.

In some examples, one or more of the sets of output data 210 can further include a confidence score indicative of how likely it is that the identified action would further the target task and/or response to the NL query 202. An action can be selected from the one or more sets of output data 210 based on this confidence score, e.g., the action in the set of output data 210 with the highest confidence score can be selected to be implemented. In some examples, a threshold confidence score is applied, e.g., the selected action is selected from one or more of the sets of output data 210 that have a higher confidence score than the threshold confidence score. If no set of output data 210 has a higher confidence score than the threshold value, a default action may be performed, e.g., outputting a request to the user for a user interaction with the GUI, clarification and/or further input data. In some examples, the output data may indicate that enough information is available to answer the NL query 202.

The indication of an action type contained in a given set of output data 210 can include data that identifies an action from a possible set of actions that are performable via the GUI. Such data may, for example, be in the form of a JSON file, token or other identifier that is associated with an action type. The set of possible actions, in some examples, can include a set of atomic actions, e.g., individual actions that can be performed via the GUI that cannot be broken down into a sequence of smaller actions. The set of atomic actions may be “interface complete”, i.e., any action that can be taken via the GUI can be built up from the set of atomic actions. Examples of such actions can include: a click; a double-click; entering/typing text; moving a cursor; an input touch, drag or other gesture; performing a copy, cut or paste action; and/or the like.

In some examples, the set of possible actions can further include one or more compound actions, i.e., an action that is a sequence of a plurality of atomic actions. Such compound actions allow a complex action to be performed based on a single output from the multi-modal model.

In some examples, the set of possible actions can include a set of one or more interrupt actions that cause a request/response to be output via the graphical user interface to the user. For example, the set of interrupt actions can include one or more requests for the user to manually perform an action through the GUI, e.g., to input sensitive data, such as login information, pecuniary information, etc. The method 200 may, in some examples, resume after the user has manually performed the action. Alternatively, or additionally, the set of interrupt actions can include one or more termination actions, e.g., that provide an output indicating that the task has been completed or that the system has failed to perform the task.

As some non-limiting examples, the set of actions can include one or more of the following:

An answer action, for when the system has enough information to provide an answer to the NL query 202:
{{
“action”: “answer”,
“answer”: “Provide an answer to my objective”,
}}

A click action for clicking on an element, such as a link, icon or button:
{{
“action”: “click”,
“click_element_index”: index from clickable elements section,
“click_element_text”: “Element text”,
“needs_more_actions”: “YES/NO—say if you need me to perform more actions to get the answer after I perform this click”,
“thought”: “An explanation as to why you're doing this action and why you can't answer the question yet.”,
}}

An objective met action, for when the NL query 202 asks for an action to be performed but the objective was already met. For example, if the NL query asks to remove items from a shopping cart but the cart is already empty:
{{
“action”: “objective_met”,
}}

A Navigate to URL action for if the query indicates that the system should navigate to a different URL. This is often the first step in a multi-step process, and can be used if no screenshot of a GUI is available, e.g., when a browser has not yet loaded a URL:
{{
“action”: “navigate”,
“url”: “https://www.example.com”,
“partial_answer”: “Optional information for storage for a later full answer. Useful when part of a multi-part task has been completed and the system needs to remember the state and/or some retrieved data for later.”,
}}

An alert acceptation action, for when an alert dialog or prompt dialog is present on the page and needs to be handled before the method can proceed:
{{
“action”: “accept_alert”,
“input_text”: “text you'd like to enter in the dialog if alert is a prompt dialog”,
}}

A text entry action, for entering text into a <input> or <textarea> field. In some examples, this is only used for text entry into input and textarea html elements and no other elements:
{{
“action”: “enter_text”,
“text_element_index”: index of the <input> or <textarea> to select from the clickable elements section,
“text”: “The text you'd like me to enter”,
}}

A Login action for logging in to an application, service a/or website:
{{
“action”: “login”,
“username_element_index”: index of the username field to select from the clickable elements section,
“password_element_index”: index of the password field to select from the clickable elements section,
“login_button_index”: index of the login button to select from the clickable elements section
}}

Many other examples are possible.

The multi-modal model 208 is, in some examples, based on a fine-tuned VLM model. The VLM model has been finetuned on a training dataset including a set of training examples, each training example containing one or more GUI images 204 and the corresponding set of structural information 206, a user query 202 and one or more ground truth sets of output data (i.e., actions and respective indices) that each correspond to a respective augmented GUI image. The VLM model 208 is finetuned to predict a set of output data given an input query, GUI image and structural information 206. Prior to fine-tuning, the VLM model may have been pretrained on generic VLM tasks using any of the methods known in the art.

The output of the multi-modal model 208 can be used to generate instructions for the system to perform the identified action, for example, at location indexed in the output data. For example, the output of the multi-modal model 206 can be converted to API instructions, e.g., using a predefined mapping of actions to API commands. As another example, the output of the multi-modal model 206 can be converted to code that, when executed, causes the system to perform the identified action. For instance, the output of the multi-modal model 206 can be “action:click target:button_id_4”, which indicates the identified action is a button click directed to an interactable element of the GUI indexed as “4”, and the code can be generated based on the output of the multi-modal model 206 (e.g., using another pass over the VLM model 208 or another generative model). As yet another example, the output of the multi-model model 206 can be code (e.g., using native code generation capabilities of a multi-modal model) that, when executed, causes the system to perform the identified action. For instance, the output of the multi-modal model 206 can be:
wait=WebDriverWait(driver, 10)
button=wait.until(EC.element_to_be_clickable((By.ID, “myButton”)))
button.click( )
   which, when executed, causes the VLM model 208 to perform a button click as the identified action.

Many other examples are possible.

In some examples, the multi-modal model 208 can make use of a password manager to log into applications and/or webpages and access information that is behind an account login. The multi-modal model 208 (and the application executing it) does not see/enter/otherwise have access to the username and password, rather, the password manager can auto-fill in the username and password in the virtual environment using previously saved account info. The multi-modal model 208 can see that this information is already filled-in via the image of the GUI, and therefore causes the application to click a ‘login’button (or equivalent).

Turning now to FIG. 3, an overview of an example system 300 for responding to an input prompt to an LLM using one or more external applications is illustrated. The method may be performed by one or more computing systems, such as the NL based response system 120 of FIG. 1 and/or computing device 610 described herein with respect to FIG. 6.

A computer system, such as an NL-based response system 306 (e.g., an instance of the NL based response system 120 described herein in relation to FIG. 1), receives an input query 302 (also referred to herein as a natural language query) via a user application 304 on a user device. The input query 302 can include natural language input that explicitly and/or implicitly raises a query that requires data to be retrieved from and/or actions to be performed via one or more external applications 308A, 308B, 308C (e.g., applications that are external to the NL-based response system 306, such as one or more of the further application 160 described herein in relation to FIG. 1). Based on the input query 302, the system can access a relevant external application from one or more external applications 308A, 308B, 308C, e.g., by navigating to a URL relating to the application and retrieving GUI information from the external application relating to a current GUI state 310 of the application, e.g., structural information relating to the current GUI and, in some examples, an image of the GUI. The current GUI state 310 is, in some examples, used by a GUI image generator 312 to generate an image of the GUI 314, e.g., an annotated image of the GUI. Although only three applications are depicted in FIG. 3, it should be understood that is for the sake of illustrating various techniques contemplated herein and is not meant to be limiting. Rather, it should be understood that any number of applications may be available.

An input preparation engine 316 uses the image of the GUI 314, the structural information relating to the GUI, and the input query 302 to generate an input 318 for one or more VLMs 320, e.g., an input prompt. The one or more VLMs process the input query to generate output data 322 indicating one or more actions to be taken. An action selection engine 324 can process the output data 322 to generate instructions 326 for performing an action via the GUI of the external application and/or for providing output to the user application 304, e.g., an intermediate response 328 or a response 330 to the query.

The external application receives the instructions and takes one or more actions 326 through the (virtual) GUI of the application based on the instructions. This causes the virtual GUI to be updated. The state of the updated virtual GUI is then provided to the NL-based response system 306.

The process may be iterated/repeated using the state of the updated virtual GUI (and subsequent update GUI states) to perform multiple actions to gather enough data to respond to the user query. In some examples, the NL-based response system 306 can provide instructions for multiple applications, e.g., a first set of iterations can be used to control a first application in order to retrieve information from the first application (e.g., application 308A) for responding to the user query, and a second set of iterations can be used to control a second application (e.g., application 308B) in order to retrieve information from the second application for responding to the user query.

The user may subsequently submit one or more further input queries. The one or more further queries may follow-on from the input query 302, e.g., asking for additional information or clarification, or asking for one or more further actions/tasks to be performed through the application.

The input query 302 can correspond to the input query described in relation to NL query 202 of FIG. 2. As an example, the input query 302 may be “Make a list of my upcoming meals”.

The one or more applications 308A-308C may correspond to the further applications described in relation to FIG. 1. The one or more applications 308A-308C may be executed in a virtual machine, e.g., secure virtual environment. The NL-based response system 306 does not, in some examples, have full access to the applications beyond sending them instructions to take one or more of the actions 326 and receiving GUI state data 310.

In some examples, a GUI state is not initially available for an application/webpage, since the application/webpage has not yet been launched/loaded. Consequently, the first action is often to launch the application and/or navigate to a webpage, e.g., using a URL. Contextual information, such as a user browser history, browser bookmarks, and/or application usage statistics may be used to determine which webpage to navigate to and/or which application to launch.

Following the example of the meal list, one of the external applications 308A-08C may be a meal planner application that is frequently accessed or bookmarked by the user. Based on determining that the query relates to this application (or webpage accessible through this application), the NL-based response system 306 causes the meal planner application (or webpage) to be instantiated, e.g., in a secure virtual environment.

The GUI information relating to a current GUI state 310 of the application can include structural information relating to the GUI, e.g., data indicating a layout of elements in the GUI. An example of such structural information is the Document Object Model (DOM) of a webpage. In some examples, the GUI information 310 can further include an image of the current state of the GUI. In other examples, the image of the GUI is generated from the structural information, e.g., by the GUI annotation engine 312.

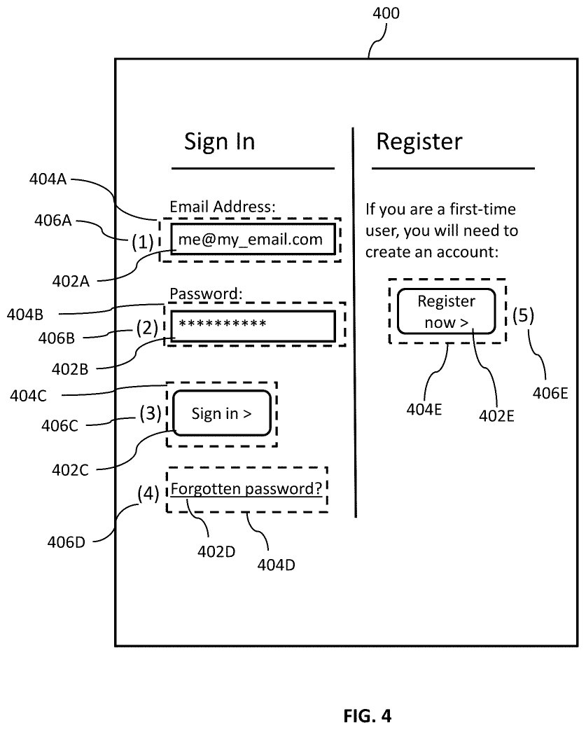

For example, after initializing the meal planner application, the NL based response system 306 may receive structural information relating to the login page of the application. The structural information may indicate that the GUI can include an email text entry box, a password entry text box, a sign-in button, a forgotten password link, and a registration button, e.g., as described in relation to FIG. 4. In some examples, the email text entry box and password entry text box may be pre-populated by a password manager application of the secure virtual environment in which the external application is being executed. The password may be obscured in the structural information.

The GUI image generator 312 uses the received structural image generation to generate a GUI image 314 of the current state of the GUI 310. The GUI image 314 may be an annotated image of the GUI including an index for each of the interactable elements in the GUI. In some examples, generation of an annotated image of the GUI is further based on a GUI image 314 received from the external applications 308A-308C. Alternatively, in some examples, an unannotated image of the GUI is generated from the structural information.

In some examples, the structural information is edited to index the interactable elements of the GUI. For example, a DOM may be edited to add an index for each of the interactable elements indicated in the DOM. Alternatively, or additionally, the elements of the structural information that relate to the interactable elements may be extracted from the structural information, and the rest of the structural information discarded. The annotated image of the GUI may be generated from this edited structural information.

The VLM input 318 can include the input query 302, at least a part of the structural information for the GUI (e.g., the DOM), and the GUI image 314 (either annotated or unannotated). The VLM input 318 may be formulated as a prompt for the VLM, e.g., a predefined prompt template may be populated with the input query 302, the structural information for the GUI, and the GUI image 314. In some examples, the VLM input 318 can further include a list of actions taken at previous iterations in furtherance of responding to the user query.

The output data 322 can include data indicating one or more actions to be taken, either by the external applications 308A-308C or the NL-based response system 306. The output data 322 can include an indication of the type(s) of action(s) to be taken and a location in the GUI for taking the action(s). In examples where an annotated GUI image is used, the location in the GUI for taking the action(s) is indicated by an index of the corresponding interactable element of the GUI.

For example, for the login page of the meal planner application, a first set of output data 322 corresponding to a first iteration may indicate that a pop-up should be closed. A second set of output data 322 corresponding to a second iteration may indicate that a “click” action should be performed on a sign-in button in order to log the user into the application. A third set of output data 322 corresponding to a third iteration may indicate a navigation action to a meal timetable page. A fourth set of output data 322 corresponding to a fourth iteration may indicate a response should be provided to the user based on the contents of the timetable page. The process can be iteratively performed to perform a task on behalf of the user that provided the input query 302.

The output data 322 may, in some examples, indicate that an intermediate output 328 should be output to the user via the user application 304. The NL based response system 306 may cause the intermediate output 328 to be rendered via the user application. Examples of such intermediate output 328 include, for example, a description of the actions that the system 300 is currently performing, e.g., a description of the actions taken through the GUI of the application. In some examples, such intermediate output 328 is provided for every action taken. In other examples, such intermediate output 328 is provided for a proper subset of the actions. The degree to which such intermediate output 328 is provided is, in some examples, a user controllable attribute. For example, the user can set a level of explanation provided, ranging from none to every action taken by the NL based response system 306.

In some examples, the intermediate output 328 can include a request for user input via the user device. The NL based response system 306 may, in some such examples, pause further actions being taken until the user input is received. For example, the intermediate output 328 can include a request that the user confirm that they wish to proceed with an action. Such confirmation can be useful at “one-way doors” in a process taken through an application, e.g., authorizing a payment, deleting and/or editing information, submitting a finalized request, etc.

Returning to the example of the meal query, the intermediate output can include the text “Navigating to the meal planner application”, followed by “I need to close this pop-up” for the first iteration, and “There we go, that's the right page. I'm reading the DOM and . . . ” for the third iteration, and so on.

When the NL based response system 306 has gathered enough data from the application(s) 308A-308C, the NL based response system 306 can generate a response 330 (e.g., a natural language response) to the input query 302, e.g., based on output data 322 of the VLM(s) 320. In some examples, the response 330 can include one or more images, e.g., images obtained from the one or more application 308A-308C. The response 330 is output via the client device, e.g., as part of an assistant application or otherwise. In some examples, the response includes at least a part of the data/information gathered during the sequence of actions.

Returning to the example of the meal query, the response 330 may be “Here are your upcoming meals: Roasted Garlic Chicken; Roasted Red Pepper Tortellini & Italian Sausage; Shredded Chicken Taco Bowl; Creamy Whole-Grain Mustard Pork Chop”. One or more images of the upcoming meals may also be provided.

The user may input further queries through the user application 304 subsequent to receiving the response 330. For example, the user may input the additional query “Instead of Garlic Chicken, please add another sausage meal”. The system 300 may then perform a sequence of actions to cause the meal application to remove the garlic chicken meal and add another sausage-based meal to the list of upcoming meals.

Turning now to FIG. 4, an example of an annotated/marked-up image 400 of a GUI is illustrated. In the example shown, the GUI is a web browser showing a login webpage for a service, though in alternative examples, the GUI can be an operating system GUI, a tool GUI, or the GUI of another type of application. Many other examples are possible.

The image of the GUI can include a plurality of interactable GUI elements, including: an email address entry box 402A for entry of an email address of the user; a password entry box 402B for entering a password of the user; a sign in button 402C for indicting that the login details have been entered; a forgotten password link 402D for resetting a password or performing some other recovery action; and a registration button 402E for registering a new account. In the example shown, the email address field and password field have already been filled in, e.g., by a password manager application and/or by user entry.

Each interactable element of the GUI has a corresponding bounding box 404A, 404B, 404C, 404D, and 404E, respectively, in the annotated image of the GUI, each of which is associated with a respective numerical index 406A, 406B, 406C, 406D, and 406E, respectively. In the example shown, the bounding boxes 404A, 404B, 404C, 404D, and 404E are dashed boxes, though the bounding boxes may, in other examples, be solid boxes, dotted boxes or the like. In the example shown, each index is adjacent to its respective bounding box, though in other examples at least some of the indices 406A, 406B, 406C, 406D, and 406E may be contained within their respective bounding boxes 404A, 404B, 404C, 404D, and 404E. In some examples, bounding boxes are not used; instead the index for each interactable element is positioned at or near the interactable element.

The annotated image of the GUI 400 for a web page may be generated from the DOM of the webpage. The DOM indicates the elements of the webpage and their respective locations in which the web page is rendered. In some examples, the DOM may be edited directly to incorporate the bounding boxes and indices, e.g., the bounding boxes and their respective indices are added as additional elements to the DOM. Alternatively, a DOM interpretation API can be used to interpret the DOM and determine the locations of the bounding boxes and their respective indices.

In some implementations, any actions for interacting with the plurality of interactable GUI elements depicted in FIG. 4 can be determined using a single call to the LLM/VLM. In additional or alternative implementations, any actions for interacting with the plurality of interactable GUI elements depicted in FIG. 4 can be determined using multiple calls to the LLM/VLM.

Turning now to FIG. 5, a flowchart that illustrates an example method 500 for controlling a user interface based on NL input is depicted. The method 500 corresponds to the methods 200 and 300 described in relation to FIGS. 2 and 3, respectively. For convenience, the operations of the method 500 are described with reference to a system that performs the operations. This system of the method 500 includes one or more processors, memory, and/or other component(s) of computing device(s) (e.g., the client device 110 of FIG. 1, the NL-based response system 120 of FIG. 1, computing device 610 of FIG. 6, and/or other computing devices). Moreover, while operations of the method 500 are shown in a particular order, this is not meant to be limiting. One or more operations may be reordered, omitted, and/or added.

At block 552, the system receives an input query via a user device. The input query can include an input text query. The query can be one formulated based on user interface input at a client device, such as typed input, voice input, selected input, etc. The input text query can be, for example, a voice query or a typed query. In some implementations, when the query includes content that is not in textual format, the system can convert the query to a textual format or other format. For example, if the query is a voice query the system can perform automatic speech recognition (ASR) to convert the voice query into textual format.

The input query may relate to a target task. The target task is, in some examples, referred to explicitly on the input query, e.g., the input query explicitly requests that a task be performed. The target task is, in some examples, referred to implicitly on the input query, e.g., the input query can include a request for information that requires a navigation and/or retrieval task to be performed in order to respond to the query. For example, the input query may be “Show me a graph of my water usage over time”. Such an input query implicitly requires that the system access data relating to the water usage of a user, e.g., via a water utility application.

In some examples, prior to the operations of block 554, the system navigates to a URL through a GUI based on the natural language query. For example, the system may identify one or more entities referred to in the user query, and navigate to a URL related to the entity (e.g., to the URL of a webpage of the entity or an application of the entity). Continuing with the example of the water usage, the query input query implicitly relates to the water utility company of the user. Consequently, the system may navigate to the webpage of the water utility company of the user.

At block 554, the system inputs, into a multi-modal ML model, input data including the natural language query, an image of a current GUI, and structural data indicating a layout of the current GUI. The current GUI image is, in some examples, an image of a “virtual” GUI, i.e., a GUI of an application that is not presently displayed to the user via the user device, but is executed in a virtual environment, e.g., a secure environment in the cloud or locally on a client device. In some examples, the current GUI is the GUI of the current application displayed via the user device. In some examples, the application from which the current GUI is taken may change during the iterations of the method, e.g., one or more actions may be taken via a GUI of a first application, and one or more actions may be taken via a GUI of a second application (or further applications).

The structural data indicates the relative locations of the various elements of the GUI and the properties of the elements, e.g., data indicating the interactable elements of the GUI and, in some examples, the interactions available at an interactable element. An example of such structural data is document object model (DOM) data for a webpage/browser. It will be appreciated that many other examples of structural data for a GUI can alternatively be used.

In some implementations, the image of the graphical user interface is annotated with data indicating the interactable elements of the GUI and a respective index for each interactable element, i.e., one or more indexed regions corresponding to respective interactable elements of the GUI. The annotated image of the GUI is, in some examples, derived from the structural data indicating the layout of the GUI.

For example, in some implementations, the image of the GUI can include an overlay for the GUI. The overlay for the GUI indicates respective locations of the one or more indexed regions and respective indices of the one or more indexed regions, e.g., a bounding box for each interactable element and a respective index (e.g., a number) for each interactable element.

At block 556, the system generates, using/by the multi-modal ML model and based on the input data, a set of output data indicative of an action to be taken via the current graphical user interface in furtherance of responding to the natural language query.

In some implementations, the multi-modal ML model generates a plurality of candidate actions, each with a respective indexed location. Each action is further associated with a respective confidence score indicating a likelihood/probability that the action will advance the target task. In some implementations, the confidence score is generated by the multi-modal ML model, i.e., the output data can further include the confidence score. In some implementations, the system uses a further ML model to generate the confidence scores. The confidence score for each candidate action is compared to a threshold confidence value/score. If no candidate action has a confidence score that exceeds threshold value, the system causes a request user input to be output via the or another GUI.

The action can include one or more of: a navigation action; a text entry; a cursor click; a touch input; a cursor click and drag; a deletion action; a cut action; a copy action; and/or a paste action. The action can include the input of sensitive data, e.g., login details for a user account and/or user personal data.

At block 558, the system causes the action to be taken via the current GUI. This updates the current GUI to an updated current GUI. The system may convert the output of the multi-modal ML model into instructions that can be executed to cause the actions to be taken via the user interface, e.g., to perform the indicated action at the target interactable element.

Operations 554-558 are, in some implementations, iterated for a plurality of iterations, The iterations may be performed until a termination condition is met. An example of a termination condition is the system determining that the system is able to respond to the user query, e.g., that enough information has been received to be able to generate a response to the input query with a confidence above a threshold value. A further example of a termination condition is the system determining that the sequence of actions has reached a point where further user input is required to proceed, e.g., that the user is required to enter login details or perform some procedure (e.g., two-factor authentication) that the system cannot perform itself in order to proceed.

Continuing with the example of water usage, the system iterates operations 554-558 to login to the user account, navigate to a page containing information relating to the user's water usage, and extract information relating to the water usage.

In some examples, the system outputs, for at least one of the iterations, an indication of the action to be taken to be output via the user device. For example, the system may cause natural language output describing one or more of the actions the system is taking in furtherance of the user query. The natural language output may be output at the user device via the application through which the user input the query, e.g., via the same text-based assistant application. Continuing with the example of water usage, the system may output the text “Navigating to your water utility website. Looks like I need to click on my account. Now I need to sign in.”

At operation 560, the system generates, by the multi-modal machine learning model, the response to the natural language query based at least in part on the natural language query and an updated current graphical user interface. The response to the natural language query includes one or more results of the actions from the one or more iterations of operations 554 to 558.

For example, continuing with the example of water usage, the system may generate a graph of the water usage of the user based on the received data.

At operation 562, the system causes the response to the natural language query to be output via the user device. For example, the system can cause the response to be rendered graphically in an interface of an application of a client device via which the query was submitted. As another example, the system can additionally or alternatively cause the response to be audibly rendered via speaker(s) of a client device via which the query was submitted.

Turning now to FIG. 6, a block diagram of an example computing device 610 that may optionally be utilized to perform one or more aspects of techniques described herein is depicted. In some implementations, one or more of a client device, cloud-based automated assistant component(s), and/or other component(s) can include one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some, or all, of the modules described herein. For example, the storage subsystem 724 may include the logic to perform selected aspects of the methods disclosed herein, as well as to implement various components depicted in FIG. 1.

These software modules are generally executed by processor 614 alone or in combination with other processors. Memory 625 used in the storage subsystem 624 can include a number of memories including a main random access memory (RAM) 60 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by processor(s) is provided and includes receiving a natural language query via a user device. The method further includes processing, by a multi-modal machine-learning model, the natural language query to generate a response to the natural language query. The processing includes, for one or more iterations: inputting, into the multi-modal machine-learning model, input data including the natural language query, an image of a current graphical user interface and structural information indicating a layout of the current graphical user interface; generating, by the multi-modal machine-learning model and based on the input data, a set of output data indicative of an action to be taken via the current graphical user interface in furtherance of responding to the natural language query; causing the action to be taken via the current graphical user interface to update the current graphical user interface; and generating, by the multi-modal machine-learning model, the response to the natural language query based at least in part on the natural language query and an updated current graphical user interface. The method further includes causing the response to the natural language query to be output via the user device.

These and other implementations of technology disclosed herein can optionally include one or more of the following features.

In some implementations, the structural information indicating a layout of the current graphical user interface can include a list of one or more interactable elements in the current graphical user interface and respective locations for the one or more interactable elements in the current graphical user interface.

In additional or alternative implementations, the structural information indicating a layout of the current graphical user interface can include at least a part of a set of document object model, DOM, data for the current graphical user interface.

In additional or alternative implementations, the image of a current graphical user interface can include one or more indexed regions corresponding to respective interactable elements of the current graphical user interface.

In some of those additional or alternative implementations, the image of the current graphical user interface can include an overlay for the current graphical user interface, the overlay can indicate respective locations of the one or more indexed regions and respective indices of the one or more indexed regions.

In some further of those additional or alternative implementations, the overlay can include one or more bounding boxes, and each bounding box can correspond to a location of a respective interactable element of the graphical user interface.

In various of those additional or alternative implementations, the method can further include, for the one or more iterations: generating the image of the current graphical user interface, including generating the one or more indexed regions from the structural information indicating a layout of the graphical user interface.

In additional or alternative implementations, the method can further include, prior to the one or more iterations, navigating to a URL through the graphical user interface based on the natural language query.

In additional or alternative implementations, the method can further include, at one or more of the one or more iterations, causing an indication of the action to be taken to be output via the user device.

In additional or alternative implementations, causing the action to be taken via the current graphical user interface to update the current graphical user interface can include performing the action in secure virtual environment implementing the graphical user interface virtually; and for one or more of the iterations, the action to be taken via the current graphical user interface, the method can further include: retrieving a username and/or password from the secure environment; and inputting the username and/or password into an interactable of the current graphical user interface.

In additional or alternative implementations, the one or more iterations can include a plurality of iterations and: for one or more of the iterations, the action to be taken via the current graphical user interface can be an action in a first application; and for a further one or more of the iterations, the action to be taken via the current graphical user interface can be an action in a second application.

In additional or alternative implementations, the method can further include receiving a speech input; and generating, using a speech-to-text method, the natural language query from the speech input.

In additional or alternative implementations, the action can include one or more of: a navigation action; a text entry; a cursor click; a touch input; a cursor click and drag; a deletion action; a cut action; a copy action; and/or a paste action.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform operations of any of the aforementioned methods. Some implementations also include a computer program product including instructions executable by one or more processors to perform operations of any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
receiving a natural language query via a user device;
processing, by a multi-modal machine-learning model, the natural language query to generate a response to the natural language query, the processing comprising:
for one or more iterations:
inputting, into the multi-modal machine-learning model, input data comprising the natural language query, an image of a current graphical user interface and structural information indicating a layout of the current graphical user interface;
generating, by the multi-modal machine-learning model and based on the input data, a set of output data indicative of an action to be taken via the current graphical user interface in furtherance of responding to the natural language query; and
causing the action to be taken via the current graphical user interface to update the current graphical user interface; and
generating, by the multi-modal machine-learning model, the response to the natural language query based at least in part on the natural language query and an updated current graphical user interface; and
causing the response to the natural language query to be output via the user device.

2. The method of claim 1, wherein the structural information indicating a layout of the current graphical user interface comprises a list of one or more interactable elements in the current graphical user interface and respective locations for the one or more interactable elements in the current graphical user interface.

3. The method of claim 1, wherein the structural information indicating a layout of the current graphical user interface comprises at least a part of a set of document object model, DOM, data for the current graphical user interface.

4. The method of claim 1, wherein the image of a current graphical user interface comprises one or more indexed regions corresponding to respective interactable elements of the current graphical user interface.

5. The method of claim 4, wherein the image of the current graphical user interface comprises an overlay for the current graphical user interface, the overlay indicating respective locations of the one or more indexed regions and respective indices of the one or more indexed regions.

6. The method of claim 5, wherein the overlay comprises one or more bounding boxes, wherein each bounding box corresponds to a location of a respective interactable element of the graphical user interface.

7. The method of claim 4, the method further comprising, for the one or more iterations:
generating the image of the current graphical user interface, comprising generating the one or more indexed regions from the structural information indicating a layout of the graphical user interface.

8. The method of claim 1, further comprising:
prior to the one or more iterations, navigating to a URL through the graphical user interface based on the natural language query.

9. The method of claim 1, further comprising, at one or more of the one or more iterations:
causing an indication of the action to be taken to be output via the user device.

10. The method of claim 1, wherein:
causing the action to be taken via the current graphical user interface to update the current graphical user interface comprises performing the action in secure virtual environment implementing the graphical user interface virtually; and
for one or more of the iterations, the action to be taken via the current graphical user interface comprises:
retrieving a username and/or password from the secure environment; and
inputting the username and/or password into an interactable of the current graphical user interface.

11. The method of claim 1, wherein the one or more iterations comprises a plurality of iterations and wherein:
for one or more of the iterations, the action to be taken via the current graphical user interface is an action in a first application; and
for a further one or more of the iterations, the action to be taken via the current graphical user interface is an action in a second application.

12. The method of claim 1, further comprising:
receiving a speech input; and
generating, using a speech-to-text method, the natural language query from the speech input.

13. The method of claim 1, wherein the action comprises one or more of: a navigation action; a text entry; a cursor click; a touch input; a cursor click and drag; a deletion action; a cut action; a copy action; and/or a paste action.

14. A system comprising
at least one processor; and
memory storing instructions that, when executed, cause the at least one processor to be operable to:
receive a natural language query via a user device;
process, by a multi-modal machine-learning model, the natural language query to generate a response to the natural language query, the processing comprising:
for one or more iterations:
input, into the multi-modal machine-learning model, input data comprising the natural language query, an image of a current graphical user interface and structural information indicating a layout of the current graphical user interface;
generate, by the multi-modal machine-learning model and based on the input data, a set of output data indicative of an action to be taken via the current graphical user interface in furtherance of responding to the natural language query; and
cause the action to be taken via the current graphical user interface to update the current graphical user interface; and
generate, by the multi-modal machine-learning model, the response to the natural language query based at least in part on the natural language query and an updated current graphical user interface; and
cause the response to the natural language query to be output via the user device.

15. The system of claim 14, wherein the structural information indicating a layout of the current graphical user interface comprises a list of one or more interactable elements in the current graphical user interface and respective locations for the one or more interactable elements in the current graphical user interface.

16. The system of claim 14, wherein the structural information indicating a layout of the current graphical user interface comprises at least a part of a set of document object model, DOM, data for the current graphical user interface.

17. The system of claim 14, wherein the image of a current graphical user interface comprises one or more indexed regions corresponding to respective interactable elements of the current graphical user interface.

18. The system of claim 17, wherein the image of the current graphical user interface comprises an overlay for the current graphical user interface, the overlay indicating respective locations of the one or more indexed regions and respective indices of the one or more indexed regions.

19. The system of claim 18, wherein the overlay comprises one or more bounding boxes, wherein each bounding box corresponds to a location of a respective interactable element of the graphical user interface.

20. A non-transitory computer-readable media comprising computer readable instructions that, when executed by a computer, cause the computer to:
receive a natural language query via a user device;
process, by a multi-modal machine-learning model, the natural language query to generate a response to the natural language query, the processing comprising:
for one or more iterations:
input, into the multi-modal machine-learning model, input data comprising the natural language query, an image of a current graphical user interface and structural information indicating a layout of the current graphical user interface;
generate, by the multi-modal machine-learning model and based on the input data, a set of output data indicative of an action to be taken via the current graphical user interface in furtherance of responding to the natural language query; and
cause the action to be taken via the current graphical user interface to update the current graphical user interface; and
generate, by the multi-modal machine-learning model, the response to the natural language query based at least in part on the natural language query and an updated current graphical user interface; and
cause the response to the natural language query to be output via the user device.
